(19) United States
(12) Patent Application Publication
(10) Pub. No.: US 2022/0303628 A1
(43) Pub. Date: Sep. 22, 2022

(54) Interactive Participatory Event Experience - Method, process and devices for enabling event goers and individuals at home to participate in a multimedia entertainment experience by utilizing a bag of objects and a mobile app to cue participation

(71) Applicant: Reid Mack, Hollywood, FL (US)

(72) Inventor: Reid Mack, Hollywood, FL (US)

(21) Appl. No.: 17/205,450

(22) Filed: Mar. 18, 2021

(51) Int. Cl. H04N 21/478; H04N 21/2187; H04N 21/414; H04N 21/418; H04N 21/43; H04N 21/8545

(52) U.S. Cl. CPC H04N 21/478; H04N 21/2187; H04N 21/41415; H04N 21/418; H04N 21/4307; H04N 21/8545

(57) ABSTRACT

A method, process and devices, both low tech and high tech that when coupled together provides event goers and in-home viewers interaction and participation with video and audio content broadcast in a venue or payed in a private home. Venue and in-home individuals are provided and instructed to download an application to their mobile device and utilize a bag of objects they have been provided. During the broadcast/stream, the event goers or in-home viewer's mobile device will detect a distinctive part of the broadcast/stream and prompt them to use an object from their bag to participate and interact with the scene being broadcast/streamed.

### BACKGROUND OF THE INVENTION

With the proliferation of theater and home based entertainment experiences, where people sit for the most part idol while content is broadcast to them, and the rise of outdoor events based around live performances where people run the possibility of being exposed to outdoor elements such as sun and rain; along with the typical crowds and often inadequate facilities such as bathrooms that are present at such outdoor events; it is the belief that given the opportunity for a highbred experience, one in which people can experience video and audio content suitable for theater and home based broadcast while in an indoor venue promoting a festival environment, people will embrace this alternative. Additionally, allowing individuals to participate with content being broadcast/streamed into their home via utilizing hard (non-technical) objects combined with prompts from an electronic device, such as a mobile and/or in home electronic smart device will provide an enhancement to the existing entertainment experience.

As people seek new and innovated ways to be entertained, venues, such as nightclubs and bars concurrently seek ways of expanding and deepening their patron base. As a result, the opportunity for venues such as nightclubs and bars to attract an expanded patron base exists in providing an entertainment experience in the form of a video and audio broadcast coupled with patron interactivity.

The present invention is therefore directed to the problem of developing a system and method to enhance a patron's experience in a nightclub, bar or similar venue and/or in a residential home by allowing them a participatory experience with a video and audio broadcast. The present invention solves these and other problems by providing a method, apparatus and devices for allowing event goer interaction and participation with a visual and audio content broadcast (movie) while the movie is being shown to the event goer, either in a private or public venue. Patrons are provided content and cues on their mobile communication/computing devices which in turn is synced to various portion of the video and audio being broadcast in the venue, thereby enabling them to participate with the event and audio/video (movie) content.

### SUMMARY OF THE INVENTION

The invention, a method for enabling an event goer to participate with video and audio content being presented by a display device such as a video screen and/or mobile device screen includes a process of streaming, storing, and viewing the content. It further entails having the content (video and audio) interact with a software application that is present on the event goers mobile device and/or a device, either a computer, steaming/storage device. The content may have participatory points embedded, which allow a mobile device to recognize segments of the content. Each participatory point may be associated with a segment(s) in the video/audio content and an object(s) which the event goer has. The software application is storable on a computer readable media and is downloadable to a mobile computing device. The software application enables a user of the mobile computing device to register with the processor using the mobile computing device and to receive a prompt from the processor on the mobile computing device and to respond to the prompt by participating/using an object(s) in a bag, the object(s) are non-technical in nature. The processor is to send an interactive message prompt prior to each interaction point to request registered users to use an item they have in conjunction with action taking place in the broadcast content.

In one possible variant of the above standard model, a broadcast from the internet, cable, television, or some other content provider will be shown in a venue and apparatuses, devices and the process of having the content communicate with an electronic device, typically a mobile device, and that mobile device in turn will prompt event goers to utilize an item.

An alternative variation of the above model example, is that the content would be delivered via an electronic device such as a streaming stick and/or dongle. The broadcast content would contain watermarks or other identifying marks. The identifying marks would deliver a prompt to a mobile device which has a software application installed for the purpose. The prompt would instruct the mobile device user to interact with an object(s).

Additionally, there is the possibility that the model can have a coordinated content time regulation in that the system may measure and accept time stamped data from the streaming and/or stored content and the presentation device and run time data to a mobile device. A push notification timed to the video and audio content being broadcast will be sent to a mobile device to cue event goers on when to participate and use objects.

### DETAILED DESCRIPTION OF THE INVENTION

The invention relates in specific to methods and apparatuses for experiencing and participating in an event taking place in a public venue, such as a bar and/or in a home while watching video and audio content and more particularly to a method and apparatus for watching video and audio (a movie or show) in a private or public venue or in a home while participating with said content via utilizing items and an electronic device such as a mobile device or smart home electronic device.

Public Venue Example

In the public venue embodiment of the invention the method, process and devices used, generate a participatory event going experience in a public venue environment (such as a nightclub, bar, restaurant or other similar venue) by providing event goers with the ability to utilize a wireless mobile device, such as a smart phone to participate with the content being publicly displayed on the venue's screen or screens and/or audio equipment. This incarnation of the invention acts in combination with video and audio content that has been produced utilizing specialized procedures, these procedures start with the creation of the content (script, lyrics, music, etc.) and continue on throughout the production, both on the artistic side (dialogue, visuals, etc.) and the tech side with the possible insertion of (watermarks, time codes or some other identifying marks) placed within the content, although the content can be creating without markings and the timing of certain scenes in the content just noted.

The outcome of the of the invention, is that at specific times throughout the audio and video content being displayed, event goers have the ability to participate with the content via a cue from their mobile device that further informs them to use an object.

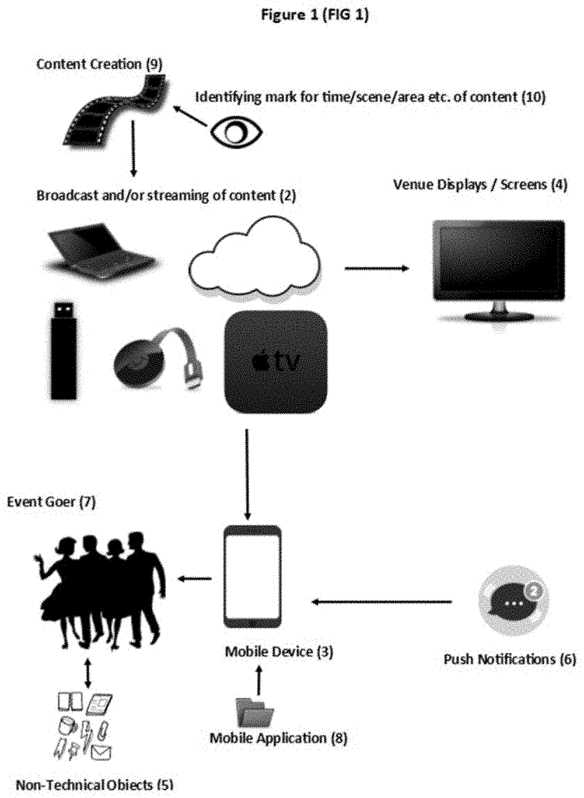

As seen in the drawings on FIG. 1, under the DESCRIPTION OF THE DRAWINGS area of this patent, there are several ways for the event goer FIG. 1, (7) to interact and participate with the broadcast content FIG. 1, (9) via an event goers electronic mobile device FIG. 1, (3) and various no-technical objects FIG. 1, (5).

The broadcast method, process and devices; such as a computer, streaming stick and/or dongle, cable connection, cloud based content delivery system or other means of broadcast FIG. 1, (2) can establish a connection (via anyone of numerous methods, such as Bluetooth and Wi-Fi) with an event goers mobile device FIG. 1, (3). In turn, the mobile device can recognize the content and read any and all marks, cues, time codes and notes that may be built into the content FIG. 1, (10). In one incarnation, a device and/or network which is responsible for broadcasting content to the displays FIG. 1, (4) within the venue will also create a connection with an event goers mobile device.

An event goer will download an application (app) FIG. 1, (8) to their mobile device, either before entering the venue, or while in the venue. Event goers mobile devices will have the ability to communicate with other electronic devices such as the device(s) that are creating the content broadcast/stream and the internet in general, either using a Wi-Fi connection or a cellular service. Another manifestation has the event goers mobile device communicate with a content server in the venue or cloud based while utilizing a service to send push notifications FIG. 1, (6) to the event goers mobile device which has the application downloaded. Common platforms that may be used include, but are not limited to Apple Push Notification service (APNs), Google Cloud Messaging (GCM), Firebase Cloud Messaging (FCM), Baidu Cloud Push, and Amazon Device Messaging (ADM). By utilizing these methods, the event goers mobile device registers with the content server and in the process transmits messages that correspond to content within the broadcast to the mobile device user, which in turn advises them on using corresponding objects.

Content, often times in the form of some kind of signal and/or message will be are exchanged between the broadcast/streaming server/processor and the event goers electronic mobile device which has the application loaded onto it. By having the application on the mobile device, the mobile device will in turn be able to identify what content is being broadcast/streamed and at what point of the broadcast/stream the content is at. Software operating on the broadcast device, either on a computer, or other device in the venue, or in the cloud; distributes prompts to an event goers mobile devices via the installed application on said device.

In-Home Example

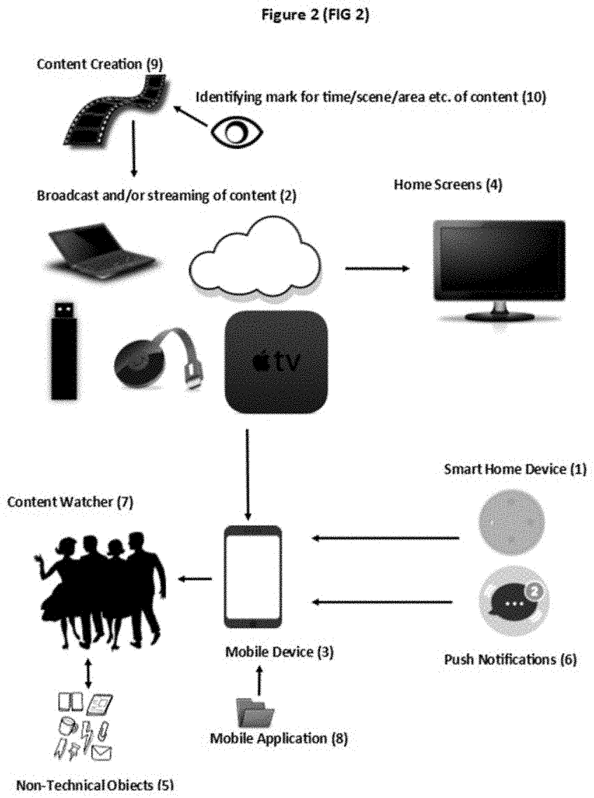

As seen in the drawings on FIG. 2, under the DESCRIPTION OF THE DRAWINGS area of this patent, the invention creates a dynamic participatory content viewing and listening experience in the home by permitting individuals to employ their electronic device, in this instance it may be a mobile device such as (smart phone, tablet, or other similar device) or a non-mobile device, such as a computer. Another manifestation has the home viewers mobile device communicate with an electronic smart home device such as Amazon Alexa, Google Home or other similar device FIG. 2, (1), to interact with the content being broadcast/streamed on their in home display device, such as a television. As an in-home experience, the invention works in combination with video and audio content that has been produced utilizing specialized procedures, these procedures start with the creation of the content (script, lyrics, music, etc.) and continue on throughout the production, both on the artistic side (dialogue, visuals, etc.) and the tech side with the possible insertion of (watermarks, time codes or some other identifying marks) placed within the content, although the content can be creating without markings and the timing of certain scenes in the content just noted.

The outcome of the of the invention in an in-home setting, is that at specific times throughout the audio and video content being displayed, viewers will have the ability to participate with the content via a cue from their mobile or home electronic smart device that further informs them to use an object.

1. A method and system for enabling event goers and viewers of home entertainment to interact and participate with video and audio content being broadcast/streamed in a public or private venue and/or in a private residence (home) by a display device comprising. A software application on a computer, in the cloud, or on an electronic device such as a streaming stick and/or dongle or installed on a home smart device combined with a software application for a mobile computing device that when used in conjunction with one another, empower a user of the mobile computing device to receive a prompt from said software application on a computer, in the cloud, or on an electronic device such as a streaming stick and/or dongle on the mobile computing device and to then in turn use an object that pertains to the prompt. Furthermore, a synchronization method for the devices, the mobile electronic device and the stationary electronic device, such as a computer or on an electronic device such as a streaming stick and/or dongle or installed on a home smart device to deliver a participatory message prompt to mobile device users to participate with the action/scene/content taking place within the video and audio content being broadcast/streamed and displayed is being claimed.

2. The apparatus according to claim 1, further comprising a wireless network to communicate with one or more mobile computing devices of one or more users. The method according to claim 1, wherein said software and hardware delivers real time prompts to one or more electronic mobile devices via a downloadable software application, which has been installed on the electronic mobile device.

3. A method for enabling an event goer and video and audio content watcher to participate with the video and audio content broadcast or streamed by loading and/or playing the video and audio content into an electronic mobile device with participatory details at various points of the content and by conveying the participatory point to the mobile device user immediately preceding the participatory point in the content.
